(19) United States
(12) Patent Application Publication
(10) Pub. No.: US 2020/0269983 A1
(43) Pub. Date: Aug. 27, 2020

(54) LUGGAGE COMPARTMENT ARRANGEMENT WITH SPINDLE DRIVE

(71) Applicant: DIEHL AVIATION LAUPHEIM GMBH, Laupheim (DE)

(72) Inventors: Johannes BERKENHOFF, Biberach (DE); Matthias HAAS, Achstetten (DE)

(21) Appl. No.: 16/788,571

(22) Filed: Feb. 12, 2020

(30) Foreign Application Priority Data
Feb. 25, 2019 (DE) 102019001320

(51) Int. Cl. B64D 11/00

(52) U.S. Cl. CPC B64D 11/003

(57) ABSTRACT

A luggage compartment arrangement for an aircraft has a base carrier which can be attached in the aircraft and a luggage compartment which is mounted so as to be pivotable about a pivot axis relative to the base carrier and/or so as to be movable translationally along a displacement path. The luggage compartment arrangement further has a spindle drive for pivoting and/or displacing the luggage compartment about the pivot axis. The spindle drive has a motor block with a rotatable spindle and a motor for driving the spindle. Via a spindle nut, at connection points, which are each radially remote from the pivot axis in the case of pivoting, the motor block is attached to the base carrier, and the spindle nut is at least indirectly attached to the luggage compartment, or vice versa.

### CROSS-REFERENCE TO RELATED APPLICATION

This application claims the priority, under 35 U.S.C. § 119, of German application DE 10 2019 001 320, filed Feb. 25, 2019; the prior application is herewith incorporated by reference in its entirety.

### BACKGROUND OF THE INVENTION

### Field of the Invention

The invention concerns a luggage compartment arrangement for an aircraft, with a base carrier which can be attached in the aircraft, and with a luggage compartment which is mounted so as to be pivotable about a pivot axis relative to the base carrier and/or so as to be movable translationally along a displacement path.

European patent EP 1 550 608 B1, corresponding to U.S. Pat. No. 7,246,771, discloses such a luggage compartment arrangement for an aircraft. Luggage bins are arranged in a longitudinal frame above the seat rows of an aircraft. A luggage bin is arranged so as to be pivotable about a rotary joint relative to the longitudinal frame by use of a carrier arm. In the opened position, the luggage bin can be loaded and unloaded through an opening. In the closed position, the bottom wall of the luggage bin terminates flush with the longitudinal frame, in order to securely stow the luggage contained in the luggage bin. In order to move the luggage bin from the opened position to the closed position, a lifting device is provided. The lifting device contains an electric motor with a gear mechanism for driving a cable roller. A drive cable runs around the cable roller over deflecting rollers, and at its end remote from the motor is attached to the top wall of the luggage bin. When the electric motor and hence the cable roller are turned clockwise, the luggage bin is lifted upward into the closed position by the drive cable.

### SUMMARY OF THE INVENTION

The object of the present invention is to specify an improved luggage compartment arrangement.

The object is achieved by a luggage compartment arrangement according to the independent claim for an aircraft. Preferred or advantageous embodiments of the invention and other invention categories arise from the further claims, the description below and the attached figures.

The luggage compartment arrangement contains a base carrier which can be or is in the mounted state attached in the aircraft, e.g. on a carrier structure provided for this purpose. The luggage compartment arrangement contains a luggage compartment which is mounted so as to be pivotable about a pivot axis relative to the base carrier and/or so as to be movable translationally along a displacement path. The base carrier is in particular configured—at least partially or also completely—as a housing for the luggage compartment.

The luggage compartment arrangement contains at least one spindle drive for pivoting and/or displacement, in particular for extension, of the luggage compartment about the pivot axis. The spindle drive has a motor block, and the motor block contains a rotatable spindle. The motor block also contains a motor for driving the spindle. The spindle in particular protrudes out of the motor block or extends away from this with its longitudinal axis. The motor in the motor block is arranged in particular transversely, e.g. at a 90° angle, to the spindle axis (longitudinal axis), but may also be positioned in an extension of or parallel to the spindle axis. This is dependent in particular on the gear mechanism selected, if such a mechanism is contained in the motor block. The driven spindle rotates about its longitudinal axis. The spindle drive also has a spindle nut. By rotation or turning of the spindle, the spindle nut is moved axially in both directions along the spindle or along the longitudinal axis, in particular towards or away from the motor block. At connection points which are each radially remote from the pivot axis in the case of pivoting, the motor block is attached to the base carrier (one of the connection points) and the spindle nut is at least indirectly attached to the luggage compartment (the other of the connection points), or vice versa (motor block to luggage compartment, spindle nut to base carrier). In the case of displacement, the connection points are in particular arranged remotely from a guide device (rail/sliding block guide/etc.) performing the displacement. The corresponding components are thus attached to each other either directly or via the interposition of other components, in particular brackets, webs, bearings, a fixing device etc.

A corresponding luggage compartment is in particular also called a chute or bin. The luggage compartment is in particular a movable overhead storage compartment as normally used in large commercial aircraft.

According to the invention, the luggage compartment opens and closes automatically.

The invention is based on the fundamental idea of fitting a motor and spindle drive to a movable luggage compartment. In operation, the spindle drive moves the luggage compartment in the closing direction, in particular from an open to a closed position, or in the opposite direction, without manual force from a person, in particular a passenger or cabin staff. In particular, automatic opening and closing of an overhead storage compartment is provided. According to the invention, even small and weak persons can operate, in particular close, a luggage compartment.

The solution according to the invention can also be applied to a bin which extends translationally out of a housing.

The invention allows better actuation of the luggage compartment for force support or even automation.

In a preferred embodiment, the motor block and/or the spindle nut are attached rotatably on the base carrier and on the luggage compartment. In this way, the relative rotations between the spindle drive, base carrier and luggage compartment can balance each other out. The rotatability exists in particular about a rotational axis running transversely to a longitudinal axis of the spindle.

In a preferred embodiment, the spindle nut has a threaded portion for engagement with the spindle, and a fixing portion which is rotatable relative to the threaded portion, for connection to the luggage compartment or the base carrier (depending on which part the spindle nut is connected to). A relative rotation between the spindle drive or spindle and counter-piece (luggage compartment, base carrier) is then balanced out correspondingly, as described above, inside the spindle nut. The fixing portion may here be arranged fixedly and need not therefore be arranged rotatably on the counter-piece.

In a preferred variant of this embodiment, the fixing portion and/or the motor block are rotatable relative to the threaded portion about a rotational axis perpendicularly to the longitudinal axis of the threaded portion. In this way, the above-mentioned relative rotations can be achieved particularly favourably.

In a preferred embodiment, the luggage compartment arrangement has at least one spindle drive which is arranged at an axial end of the luggage compartment, and/or has at least two spindle drives which are arranged at the respective axial ends of the luggage compartment (“axial” refers for example to the axial direction of the pivot axis or a longitudinal extension direction of the luggage compartment or aircraft etc.). At least one spindle drive is thus arranged at each of the two axial ends of the luggage compartment. Thus the luggage compartment can be loaded with a respective movement force at both axial ends.

In particular with smaller OHSC (overhead storage compartments) or spacers, an embodiment with a single spindle drive is conceivable.

In particular, combinations of pivot and translational movements are possible. For this, corresponding combinations of (also pivotable) displacement paths and/or (also displaceable) pivot axes are provided. Movement takes place in each case with spindle drives.

In a preferred embodiment, at least at one of its axial ends, the luggage compartment has a side wall and the spindle drive is arranged axially outside the luggage compartment on the far side of the side wall. Alternatively—if the base carrier (in particular as a housing, see above) also has an outer wall at the axial end of the side wall—the spindle drive is arranged in a gap between the side wall and the outer wall. In the first case, this avoids the spindle drive coming into contact with the interior of the luggage compartment, in particular the luggage or baggage placed therein, e.g. passenger luggage. In the second case, it is also achieved that the spindle drive is integrated inside the luggage compartment arrangement.

In a preferred embodiment, the spindle drive is not self-inhibiting. Thus in particular, the spindle nut can be moved axially on the spindle under the effect of external force. Accordingly, the luggage compartment can be operated, i.e. opened and closed, by hand without having to detach the spindle drive from the base carrier and luggage compartment.

In a preferred embodiment, the luggage compartment arrangement has a lock (in particular a latch) for mechanical locking of the luggage compartment in a closed state, and a latch sensor for detecting an operating state (e.g. open, closed, latched, malfunction etc.) of the latch. In this way, logic functions or operating modes etc. can be implemented in the luggage compartment arrangement, in particular automatic motorized opening of the luggage compartment on release of the latch, blocking of the spindle drive when the latch is locked, allowing activation of the spindle drive only when the latch is unlocked, etc.

In a preferred embodiment, the luggage compartment arrangement contains a control and analysis unit for actuating the spindle drives. This allows controlled/regulated operation of the luggage compartment arrangement. External control components etc. are thereby superfluous. In particular, the above-mentioned automation of the luggage compartment arrangement is possible.

In a preferred variant of this embodiment—in conjunction with the above-mentioned latch and corresponding latch sensor—the control and analysis unit is structured or actually configured to actuate the spindle drives on unlocking of the latch (detected by the latch sensor) for opening the luggage compartment, and/or to allow actuation of the spindle drives only when the latch is unlocked. The structuring or configuration is achieved for example by hard-wiring or programming of the control or analysis unit. The above-mentioned logic functions etc. are then implemented within the control and analysis unit.

In a preferred variant of this embodiment, the control and analysis unit is configured to actuate the spindle drives in a smooth motion mode. In operation, the luggage compartment then performs “soft” or “damped” movements, as are generally known in practice or from domestic situations, for example for cupboard doors, drawers, toilet lids in households etc. Such motion types avoid sudden movements, and hence in particular impacts or vibrations for goods carried in the luggage compartment.

In a preferred variant of this embodiment, the control and analysis unit is configured to actuate the spindle drives in a trap protection mode. This prevents trapping of objects or body parts, for example a user's hands, in the luggage compartment arrangement, in particular between the luggage compartment and the base carrier or other parts.

In a preferred variant of this embodiment, the luggage compartment arrangement contains at least one input element for actuating a movement (opening, closing etc.) of the luggage compartment, and the control and analysis unit is configured to actuate spindle drives according to the input element, so as to perform the corresponding movement. In particular, opening and closing are thus triggered by a direct or indirect (see below) actuation of the input element. The input element is in particular a knob, switch, button, proximity sensor, optical or capacitative sensor etc. This applies in particular to closing the luggage compartment, since opening, e.g. by unlocking the mechanical latch, can be detected by the corresponding above-mentioned sensor.

In a preferred variant of this embodiment, the luggage compartment arrangement contains a tip-to-run sensor (which in particular is an above-mentioned input element) for detecting touching, in particular (at least incipient) pressing closed, of the luggage compartment, and the control and analysis unit is configured to actuate the spindle drives in a tip-to-run mode or a tip-to-run routine (software). Tip-to-run means in particular that operation (running) of the spindle drive is triggered by manual starting, pressing, indicating (tapping) etc. of a closing or opening movement directly on the locker. A user need not therefore actuate any corresponding switch, control knob or similar, but merely begin to open or close the luggage compartment directly. The sensor indirectly detects this movement as an input and triggers operation of the spindle drive. The tip-to-run sensor is in particular a specific embodiment of the above-mentioned input element. In particular, a sensor which is in any case integrated in a motor of the spindle drive, e.g. a Hall effect sensor, is used as such a sensor. In particular, an existing motor electronics is used to detect a tip-to-run request (start of a tip-to-run operation).

The invention thus in particular provides a general concept with a combination of hardware (luggage compartment arrangement etc.) and software (programming of control and analysis unit etc.). The invention provides the combination of electrical and mechanical components in an aviation environment or the available installation space.

The invention thus in particular has two components, namely the corresponding hardware and the corresponding software which serves to configure or structure the hardware, as explained above. The hardware contains two spindle drives (full automatic bin unit—FABU) which are placed in or against the direction of flight in a gap (forward/aft gap) between the luggage compartment (bin) and the base carrier (housing), and a motor control unit (MCU, control and analysis unit), a sensor for detecting the latch information (latch), and an input knob (button) for triggering the closing movement of the luggage compartment. If necessary, an electrical energy accumulator may optionally be added.

The software (as programming for configuring the control and analysis unit) evaluates the various movement sequences and errors, and controls the movement of the motors. Comfort functions, such as trap protection, a tip-to-run routine or smooth motion sequence, are programmed.

Since the spindle drive (FABU) is configured to be not self-inhibiting, the entire system can be opened and closed even without a power supply (in the case of an electrical power failure).

Other features which are considered as characteristic for the invention are set forth in the appended claims.

Although the invention is illustrated and described herein as embodied in a luggage compartment arrangement with a spindle drive, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is an illustration of a luggage compartment arrangement according to the invention with a pivotable luggage compartment;

FIG. 2 is a diagrammatic, perspective view of a spindle drive from FIG. 1; and

FIG. 3 is an illustration of an alternative luggage compartment arrangement according to the invention with a displaceable luggage compartment.

### DETAILED DESCRIPTION OF THE INVENTION

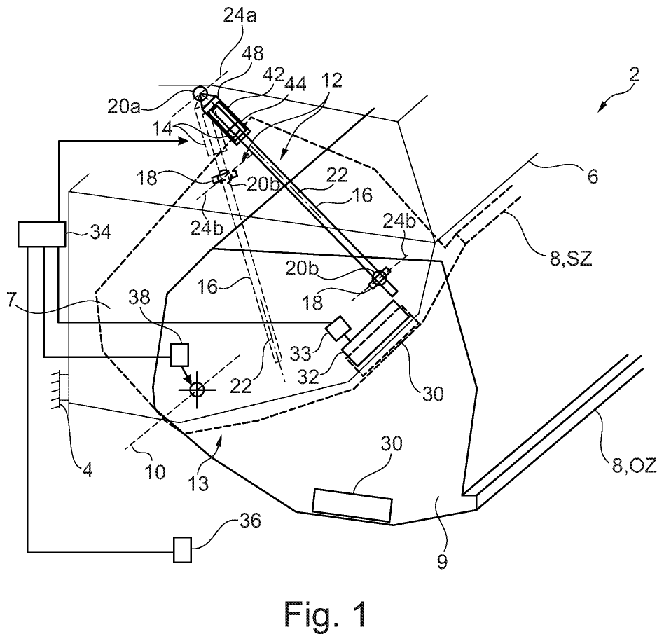

Referring now to the figures of the drawings in detail and first, particularly to FIG. 1 thereof, there is shown a luggage compartment arrangement 2 for an aircraft 4, here a passenger aircraft, of which FIG. 1 shows symbolically merely an extract of a carrier structure or inner paneling of a passenger cabin. The luggage compartment arrangement 2 contains a base carrier 6, which can be attached in the aircraft 4 or onto the carrier structure, and here is shown attached in an installed state. Therefore the luggage compartment arrangement 2 is installed in the aircraft 4. The luggage compartment arrangement 2 contains a luggage compartment 8, here a chute which is pivotable about a pivot axis 10 relative to the base carrier 6, and hence in installed state also relative to the aircraft 4. The luggage compartment 8 is shown in solid lines in FIG. 1 in an open state OZ and in dotted lines in a closed state SZ.

The luggage compartment arrangement 2 also contains two spindle drives 12, of which FIG. 1 only shows one as an example. The spindle drive 12 serves for motorized pivoting of the luggage compartment 8 about the pivot axis 10 in an opening direction and in an opposite closing direction. Each of the spindle drives 12 contains a motor block 14 with a motor 42 (see below), a spindle 16 and a spindle nut 18. At a first connection point 20a, the motor block 14 is attached to the base carrier 6; at a second connection point 20b, the spindle nut 18 is attached to the luggage compartment 8. Both connection points 20a, 20b (symbolized by circles) are radially remote from the pivot axis 10.

The spindle drive 12 shown is arranged at the axial end of the luggage compartment 8 relative to the pivot axis 10. The non-illustrated second spindle drive 12 is arranged at the opposite axial end of the luggage compartment 8. At each corresponding axial end, the luggage compartment 8 has a side wall 9 (only one is shown in FIG. 1). The spindle drives 12 are each arranged outside the luggage compartment 8, on the far side of the side walls 9. The base carrier 6, here configured as a type of housing, also has two outer walls 7 (only one is shown in FIG. 1) which each lie axially outside or next to the side walls 9 in the direction of the pivot axis 10, and thus enclose these and also the luggage compartment 8 on both sides. The spindle drives 12 are each arranged in the corresponding axial gap 13 between the side wall 9 and outer wall 7.

The spindle drives 12 are not self-inhibiting. Therefore a user can open or close the luggage compartment 8 without actuating the motor block 14 or motor 42, for example on a power failure or other fault.

To pivot the luggage compartment 8, the motor block 14 (or a motor contained therein, see below) rotates the spindle 16 about its longitudinal axis 22, whereby the spindle nut 18 is shifted on the spindle 16 along the longitudinal axis 22. The connecting points 20a, 20b are moved towards each other or away from each other, and the luggage compartment 8 is thereby pivoted about the pivot axis 10.

The motor block 14 and spindle nut 18 are attached on the base carrier 6 and luggage compartment 8 respectively at connecting points 20a, 20b so as to be rotatable about rotation axes 24a, 24b.

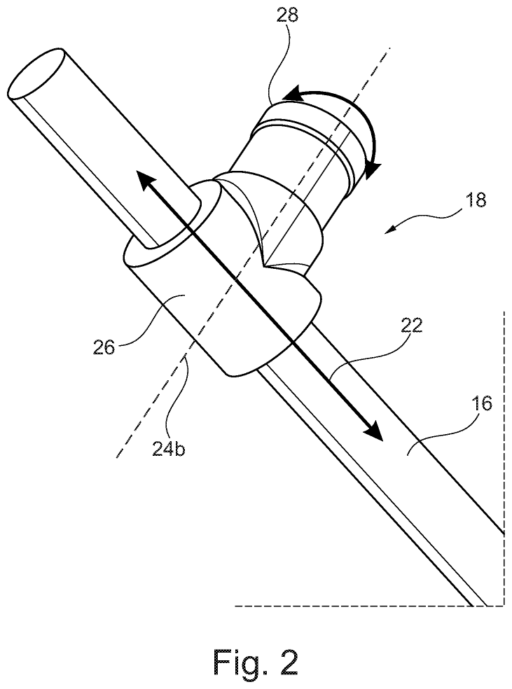

FIG. 2 shows in detail the spindle nut 18 from FIG. 1 which is displaceable on the spindle 16 along the longitudinal axis 22 by its rotation (indicated by arrow tips). In the embodiment shown here, the spindle nut 18 has a threaded portion 26 which cooperates, via an internal thread (not shown), with an external thread (not shown) of the spindle 16 for movement along the spindle 16. The spindle nut 18 also contains a fixing portion 28. This is rotatable about the rotation axis 24b relative to the threaded portion 26. The fixing portion 28 is fixedly mounted on the luggage compartment 8 at connecting points 20b. Because of the rotatability relative to the threaded portion 26, the spindle nut 18 is rotatably mounted on the luggage compartment 8.

FIG. 1 also shows the following:

The luggage compartment arrangement 2 also has a latch 30 for locking the luggage compartment 8 in the closed state SZ. For this, the latch 30 engages with a counter-piece 32. The luggage compartment arrangement 2 also has a sensor 33 for detecting an operating state of the latch 30, so that in particular the closed state SZ can be detected.

The luggage compartment arrangement 2 also contains a control and analysis unit 34 (here shown merely symbolically). This serves for actuating the spindle drives 12 (symbolized by an arrow).

The control and analysis unit 34 is configured to actuate the spindle drives 12 on unlocking of the latch, i.e. when the latch 30 is opened from the closed state SZ, in order to open the luggage compartment, i.e. to move it from the closed state SZ into the open state OZ. Furthermore, the control and analysis unit 34 is configured to allow activation of the spindle drives 12 only when the latch 30 is unlocked. Otherwise, the spindle drives 12 would e.g. attempt to open the luggage compartment 8 despite this being held in the closed state SZ by the locked latch 30.

The luggage compartment arrangement 2 also contains an input element 36 (here indicated merely symbolically), here a pushbutton. This serves to activate a movement of the luggage compartment 8, here for closure. The control and analysis unit 34 is configured to actuate the spindle drives 12 according to the input element 36, namely when this is actuated, in order to trigger a closing movement of the luggage compartment 8.

The luggage compartment arrangement 2 also contains a tip-to-run sensor 38 for detecting touching of the luggage compartment. This is indicated symbolically in FIG. 1 by a coupling with the pivot axis 10. The control and analysis unit 34 is configured to actuate the spindle drives 12 according to a tip-to-run mode. As an example, this means that if the luggage compartment 8 is in the open state OZ, a minimal lifting of the luggage compartment 8 is sufficient for the sensor 38 to detect a corresponding movement. The control and analysis unit 34 then recognizes a desire to close the luggage compartment 8 and actuates the spindle drives 12 accordingly.

The spindle drive 12 contains the motor 42 (here indicated merely symbolically), here an electric motor, a gear mechanism 44 between the motor 42 and spindle 16, and two bearings (not shown), e.g. ball bearings, for the spindle 16. A motor housing 48 serves to receive the motor 42, gear mechanism 44, bearings 46 etc.

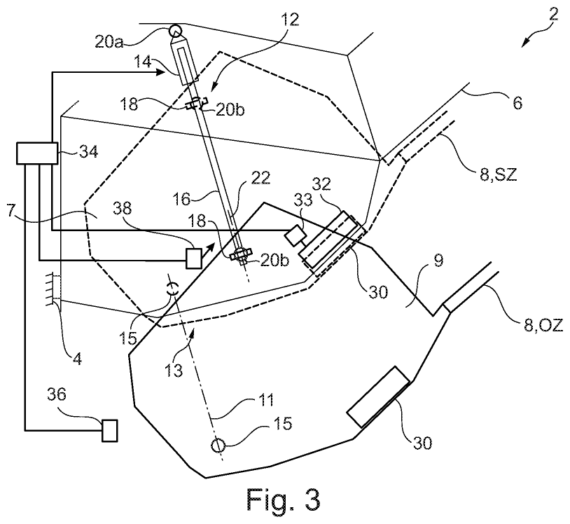

FIG. 3 shows in principle, corresponding to FIG. 1, an alternative luggage compartment arrangement 2 in which, instead of pivoting, a displacement of the luggage compartment 8 takes place along a displacement path 11 using the spindle drives 12. Instead of a linkage for pivoting about the pivot axis 10, the luggage compartment 8 contains guides 15 for moving this translationally along a displacement path 11, here on a rail guide (indicated merely symbolically) on the base carrier 6. A pivotable mounting of the spindle nut 18 on the luggage compartment 8 and of the motor block 14 on the base carrier 6, by means of rotational axes 24a,b, is no longer required. Otherwise, the statements above in relation to FIG. 1 apply accordingly.

### LIST OF REFERENCE SIGNS

2 Luggage compartment arrangement
4 Aircraft
6 Base carrier
7 Outer wall
8 Luggage compartment
9 Side wall
10 Pivot axis
11 Displacement path
12 Spindle drive
13 Gap
14 Motor block
15 Guide
16 Spindle
18 Spindle nut
20a,b Connecting points
22 Longitudinal axis
24a,b Rotational axis
26 Threaded portion
28 Fixing portion
30 Latch
32 Counter-piece
33 Latch sensor
34 Control and analysis unit
36 Input element
38 Tip-to-run sensor
42 Motor
44 Gear mechanism
48 Motor housing
OZ Open state
SZ Closed state

1. A luggage compartment configuration for an aircraft, the luggage compartment configuration comprising:
a base carrier which can be attached to the aircraft;
a luggage compartment mounted so as to be pivotable about a pivot axis relative to said base carrier and/or so as to be movable translationally along a displacement path; and
at least one spindle drive for pivoting and/or displacing said luggage compartment about the pivot axis, said spindle drive having a motor block with a rotatable spindle, a motor for driving said rotatable spindle, and a spindle nut, wherein at connection points, which are each radially remote from the pivot axis in a case of pivoting, said motor block being attached to said base carrier and said spindle nut is at least indirectly attached to said luggage compartment, or vice versa.

2. The luggage compartment configuration according to claim 1, wherein said motor block and/or said spindle nut is attached rotatably on said base carrier and on said luggage compartment.

3. The luggage compartment configuration according to claim 1, wherein said spindle nut has a threaded portion for engagement with said rotatable spindle, and a fixing portion which is rotatable relative to said threaded portion for connection to said luggage compartment or said base carrier.

4. The luggage compartment configuration according to claim 3, wherein said fixing portion and/or said motor block is rotatable relative to said threaded portion about a rotation axis perpendicularly to a longitudinal axis of said threaded portion.

5. The luggage compartment configuration according to claim 3, wherein:
said at least one spindle drive is disposed at an axial end of said luggage compartment; or
said at least one spindle drive is one of at least two said spindle drives each disposed at a respective axial end of said luggage compartment.

6. The luggage compartment configuration according to claim 1, wherein:
said luggage compartment has axial ends and at least at one of said axial ends, said luggage compartment has a side wall; and
said at least one spindle drive is disposed axially outside said luggage compartment on a far side of said side wall, or, if said base carrier also has an outer wall at an axial end of said side wall, said at least one spindle drive is disposed in a gap between said side wall and said outer wall.

7. The luggage compartment configuration according to claim 1, wherein said at least one spindle drive is not self-inhibiting.

8. The luggage compartment configuration according to claim 1, further comprising:
a latch for mechanical locking of said luggage compartment in a closed state; and
a latch sensor for detecting an operating state of said latch.

9. The luggage compartment configuration according to claim 8,
wherein said at least one spindle drive is one of a plurality of spindle drives; and
further comprising a control and analysis unit for actuating said spindle drives.

10. The luggage compartment configuration according to claim 9, wherein said control and analysis unit is configured to actuate said spindle drives on an unlocking of said latch for opening said luggage compartment, and/or to allow actuation of said spindle drives only when said latch is unlocked.

11. The luggage compartment configuration according to claim 9, wherein said control and analysis unit is configured to actuate said spindle drives in a smooth motion mode.

12. The luggage compartment configuration according to claim 9, wherein said control and analysis unit is configured to actuate said spindle drives in a trap protection mode.

13. The luggage compartment configuration according to claim 9, further comprising at least one input element for activating a movement of said luggage compartment, and said control and analysis unit is configured to actuate said spindle drives according to said input element.

14. The luggage compartment configuration according to claim 9, further comprising a tip-to-run sensor for detecting touching of said luggage compartment, and said control and analysis unit is configured to actuate said spindle drives in a tip-to-run mode.
